(19) United States
(12) Patent Application Publication
(10) Pub. No.: US 2005/0146655 A1
(43) Pub. Date: Jul. 7, 2005

(54) Optical equalisation device and corresponding system

(75) Inventors: Michel Barge, Milizac (FR); Denis Battarel, Plougonvelin (FR); Jean-Louis De Bougrenet De La Tocnaye, Guilers (FR); Pascal Gautier, Brest (FR); Antoine Tan, Brest (FR)

Correspondence Address: MERCHANT & GOULD PC, P.O. BOX 2903, MINNEAPOLIS, MN, 55402-0903, US

(73) Assignee: OPTOGONE SA, Plouzane (FR)

(21) Appl. No.: 11/018,145

(22) Filed: Dec. 20, 2004

(30) Foreign Application Priority Data
Dec. 30, 2003 (FR) 03 15594

(51) Int. Cl. G02F 1/1333

(52) U.S. Cl. 349/86

(57) ABSTRACT

This invention relates to an optical equalisation device (312) of at least one incident optical beam (40) separated in wavelength into several channels or spectral bands called demultiplexed optical beam, the device including at least two independently controllable cells (420, 430, 440) each comprising spatial phase modulation means and means of scattering the incident optical beam(s). The device is adapted such that at least one of the demultiplexed beams (312) simultaneously and approximately illuminates at least two of the cells (420, 430, 440). The invention also relates to a corresponding system.

### DOMAIN OF THE INVENTION

This invention relates to the domain of variable optical attenuators particularly in the form of strips or matrices that may for example be of the gain or channel attenuator type.

### DESCRIPTION OF PRIOR ART

Different techniques according to prior art use materials based on liquid crystals for making dynamic gain or channel equalisers. In free space spatial modulators according to prior art, wavelength λ demultiplexing is usually achieved by using a dispersive element (for example of the network, prism, etc. type), a wavelength demultiplexed image taking place on a spatially variable attenuator. Apart from the optical configuration, the main part is thus based on the use of a spatial modulator composed of elementary cells (also called pixels) modulating an electro-optical material, for example of the liquid crystal or composites type.

The state of the art describes different spatially variable electro-optic attenuator configurations based on PDLC (Polymer Dispersed Liquid Crystal) for which the liquid crystal concentration and droplet size vary. The objective with spatial modulators using PDLC type composite materials is to achieve selective attenuation in a spectral band within a range from 10 to 15 dB (for the dynamic gain equalisation DGE) or 35-40 dB (for blockers DCE).

For macroscopic optical operation of modulation starting from a PDLC, a distinction is made between two cases depending on the size of PDLC droplets resulting in distinct optical properties for the PDLC:
the case of PDLC with droplets with a size of the order of one wavelength, λ, of the incident optical beam or larger; and
the case of nano-PDLC with smaller droplets, with a size approximately equal to one tenth of the size of the wavelength λ (or smaller).

FIG. 2 shows a strip 20 comprising two elementary cells 212 and 222 illuminated by incident beams 211 and 221 respectively. The cells 212 and 222 are filled with PDLC with droplets larger than or with a size comparable to the wavelength of the incident beams (therefore corresponding to the first case). The cell 212 containing droplets 213 is not affected by any electric field. Therefore, the droplets 213 are oriented arbitrarily and an incident wavelength corresponding to the beam 211 will see liquid crystal droplets (for a size with an order of magnitude equal to λ) resulting in the appearance of a scattering phenomenon. Therefore the optical output beam 214 is scattered in several directions.

When a voltage is applied to the terminals of a cell, the average index of the filter varies and the scattering phenomenon is accompanied by an isotropic phase delay that depends on the average index. The material gradually becomes transparent under an applied field. Therefore, for each pixel, there is a spatial modulation with amplitude proportional to the electric field, accompanied by a fixed delay that depends on the field. If the modulating element is placed in an image plane of the input fibre and covers the entire optical beam, this delay results in a simple focussing fault that can be neglected.

Thus, electrodes 225 and 226 placed transversely (with respect to the incident optical beam 221) on each side of the cell 222 are used to apply an electric field. This field orients droplets 223 in the cell 222 such that the cell becomes transparent for the incident light wave. Therefore the output beam 224 is not significantly scattered.

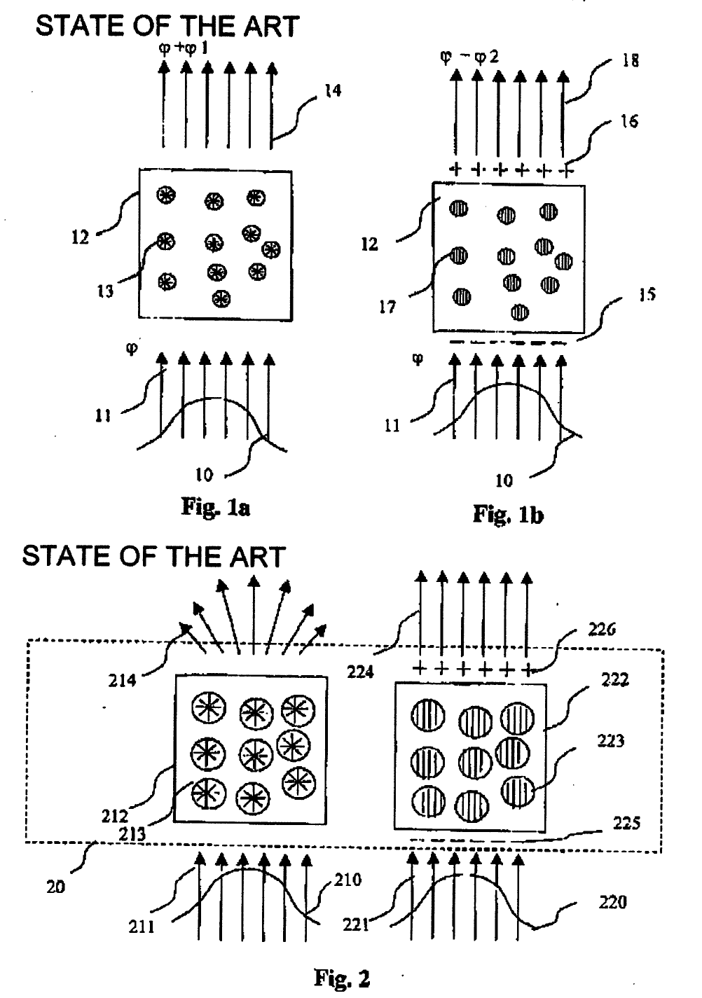

FIGS. 1a and 1b illustrate a cell 12 containing nano-PDLC. In this case, an incident light wave 10 does not see the liquid crystal droplets (smaller than a tenth of λ) contained in the cell 12, there are no longer any losses by scattering but the index is modulated.

Thus according to FIG. 1b, the cell 12 is subjected to an electric field applied by electrodes 15 and 16. The nano-PDLC droplets 17 that it contains are then oriented along this field and the cell 12 is transparent for the incident optical beam 11 that is simply phase shifted by a value δ2 corresponding to the average index associated with this field value.

On the other hand, the cell 12 shown in FIG. 1a is not subjected to any field. Although the nano-PDLC droplets 13 that it contains are oriented arbitrarily, the cell is still transparent. Therefore, the output beam 14 is not significantly scattered, unlike the case of the use of PDLC with large droplets. All that happens is a phase shift by a value δ1 corresponding to the average index with no field.

Liquid crystal based structures of the nano-PDLC and PDLC type are used in optical systems for making gain equalisers (DGE) or channel equalisers (DCE or blockers).

Thus, liquid crystal or nano-PDLCs are used in cells to shift the phase of the optical signal (anisotropic phase modulation for liquid crystal and isotropic phase modulation for nano-PDLC) with no scattering.

In this case, the cells are grouped in the form of a strip that can form independent or coupled phase shifters.

Strip structures based on nano-PDLC are composed of independent phase shifting pixels like cell 12 illustrated with reference to FIGS. 1a and 1b. Each wavelength or spectral band illuminates a single variable modulator composed of a nano-PDLC cell 12 that modulates the phase of the incident beam (the amplitude of the incident beam 11 is represented by curve 10, the amplitude being maximum on the central area of the cell 12 and approximately zero at the edges of the cell or outside it). The lateral position of each cell must be precisely controlled to assure that this condition is satisfied. This structure is only useful for an interferometric type configuration. This type of device is quite suitable for obtaining large attenuation ranges (more than 30 dB). The modulator is capable of introducing a fixed delay between the two arms of the interferometer. A first disadvantage of this technique according to prior art is the disadvantage of an interferometric assembly that is difficult to adjust and is sensitive to mechanical and temperature variations. Another disadvantage is that high voltages are necessary to obtain large phase shift values (greater than or equal to π radians). For example, a phase shift of π is obtained with a 20 μm thick nano-PDLC for an electric field of 200 Volts, which is equal to 6 V/μm.

According to one technique divulged in patent document WO 02071660 entitled “Dynamic gain equalizer” deposited in March 2002 in the name of the Xtellus (registered trademark) company, liquid crystal based cells are used to create a variable phase shift modulator. Attenuation is obtained by creation of aberrations on the incident optical beam in the plane of the modulator. Unlike the previous case in which the cells are independent, it is essential that the incident beam optical should cover several pixels. With this procedure, large dynamic ranges are obtained at the price of large phase shifts (more than π).

Moreover, techniques based on a phase filter like that described in the Xtellus document (registered trademark) require very precise positioning of the spot on the filter, which introduces a constraint on alignment and adjustment. The system described in this document also requires means with polarisation diversity.

Prior art also includes attenuators based on another principle using strongly scattering structures with small phase shifts.

Thus, patent document EP1207418 entitled “Dynamic spatial equalizer based on a spatial light modulator” deposited in the name of the Alcatel (registered trademark) company divulges a strip 20 like that illustrated with reference to FIG. 2. As already mentioned, each pixel 212 and 222 is addressed independently and therefore acts as an attenuator independently of the other pixels. Each wavelength or spectral bend illuminates a variable attenuator composed of a PDLC cell (one pixel only per wavelength) ((the amplitudes of incident beams 211 and 221 are represented by curves 210 and 220 respectively, the amplitude being maximum on the central area of the corresponding cell and approximately zero on the edges or outside this cell). The lateral position of cells 212 and 222 must be precisely controlled to assure that incident beams cover a single cell. If the effects of transverse beams due to the vicinity of other pixels (or channels) are neglected, the scattering phenomenon is predominant in attenuation of the signal reinjected into an input fibre. This phenomenon is accompanied by a fixed phase delay that does not affect the attenuation range. The advantage is the use of a PDLC requiring low control voltages. However, this technique does have several disadvantages. Thus, large attenuation ranges are very difficult to achieve (thicknesses and therefore voltages have to be increased), consequently the DGE function is preferred. Electric consumption is also relatively high. It is also badly adapted to treatment of a continuous spectrum, unless a very large spatial resolution is available, in other words including many more pixels, the pixels being smaller in size and therefore more difficult to make and more expensive to manage electronically.

Presentation of the Invention

The various aspects of the invention are intended mainly to overcome these disadvantages according to prior art.

More specifically, one purpose of the invention is to supply a dynamic gain equaliser and a corresponding system adapted to equalisation of an optical beam with a continuous or quasi-continuous spectrum over a wide spectral band.

Another purpose of the invention is to use an equaliser that can be controlled with relatively low voltages and/or a low range and that can produce large phase shifts (particularly more than π radians).

Another purpose of the invention is to obtain an optical equaliser that is relatively easy to implement and is small.

These purposes and others that will become clearer later are achieved according to the invention using an optical equalisation device of at least one incident optical beam separated in wavelength into several channels or spectral bands called demultiplexed optical beam, the device including at least two independently controllable cells each comprising spatial phase modulation means and means of scattering the incident optical beam(s), remarkable in that the device is adapted such that at least one of the demultiplexed beams simultaneously and approximately illuminates at least two of the cells.

For the purposes of this description, the fact that the beam approximately illuminates at least two cells means that not more than 99% of the energy is concentrated on a single cell.

Thus, a channel or a spectral band approximately illuminates at least two cells that are controlled in phase separately and therefore enable spatial phase modulation and attenuation by distinct scattering on each cell. Thus, according to the invention, there are several degrees of freedom used to make fine adjustments to the required attenuation, while having relatively low control voltages (and therefore consumption) for a possibly high phase shift.

The invention also has the advantages of spatial phase modulation means and scattering means without the disadvantages specific to the use of these means in isolation. Thus, the invention can be used to obtain a high attenuation range, without strong positioning and voltage constraints.

The invention can also be used in the form of strips or matrices, each strip or matrix element comprising several cells and being illuminated by one or several demultiplexed beams.

According to one particular characteristic, the device is advantageously adapted such that at least one of the demultiplexed beams simultaneously and approximately illuminates three of the cells.

For the purposes of this description, the fact that the beam approximately illuminates at least three cells means that not more than 99% of the energy is concentrated on two cells.

A device with demultiplexed beams simultaneously illuminating three cells provides a means of overcoming geometric constraints and is sufficient to obtain easily controlled equalisation. Furthermore, the use of three independently controllable cells illuminated by a channel or a spectral band provides a means of easily managing overlapping problems.

In general, two cells simultaneously illuminated by a channel or a spectral band already provides separation of phase shift and scattering commands and therefore freedom for controlling the equalisation device. When the number of pixels (or cells) illuminated simultaneously increases, the number of degrees of freedom also increases.

Preferably, the device is remarkable in that consecutive spectral bands of the demultiplexed optical beam overlap partly on at least one of the cells.

Thus, the result is quasi-continuous attenuation of the wavelength spectrum on overlapping parts.

According to advantageous characteristics, the device is remarkable in that the spatial modulation means and scattering means comprise a liquid crystal type composite material in a polymer.

A liquid crystal type composite material in a polymer or PDLC has the advantage that it is optimised to minimise losses and maximise the phase shift and the attenuation range for use with illumination of several cells by a demultiplexed beam.

Furthermore, a PDLC device is relatively easy to make, particularly in a strip type configuration; in a strip or matrix type configuration, control electrodes distinguish PDLC cells by pixelisation, the PDLC corresponding to several cells being used particularly in one or several elementary structures, each being associated with a cell.

According to one particular characteristic, the device is remarkable in that the material comprises liquid crystal droplets with a size more than one tenth of the incident wavelength.

For use in the telecommunications domain (namely within the 1450 to 1620 nm range), the droplet size is more than about 150 nm.

According to one preferred characteristic, the device is remarkable in that the material comprises liquid crystal droplets with a size approximately equal to the incident wavelength.

For use in the telecommunications domain (namely within the 1450 to 1620 nm range), the droplet size is approximately between 800 nm and 2 μm.

According to one advantageous characteristic, the device is remarkable in that the liquid crystal concentration in the material is between 75 and 80%.

According to one particular characteristic, the device is remarkable in that the spatial modulation means and scattering means include a bulk semi conducting material.

According to one particular characteristic, the device is remarkable in that the spatial modulation means and the scattering means are of the multiple quantum well type.

Thus, the use of a Multiple Quantum Well (MQW) material (using an electro-absorption phenomenon) provides a means of very strongly reducing response times (typically a few hundred nano-seconds for materials with multiple quantum wells, compared with the few hundred microseconds for PDLCs).

The invention also relates to a system characterized in that it comprises wavelength multiplexing means and a device like that described previously according to the invention.

Thus, the system is relatively well adapted to an equalisation application as a function of a wavelength or a channel length.

According to one particular characteristic, the system is used in free space.

In particular, use in free space enables greater parallelism and the treatment of a larger number of channels or spectral bands (particularly more than 32).

The advantages of the system are the same as advantages of the optical equalisation device, and they are not described in more detail.

### DETAILED DESCRIPTION OF AN EMBODIMENT OF THE INVENTION

Other characteristics and advantages of the invention will become clearer after reading the following description of a preferred embodiment given as a simple illustrative example that is in no way limitative, and the appended figures, wherein:

FIGS. 1a, 1b and 2 show optical structures based on nano-PDLC known in themselves;

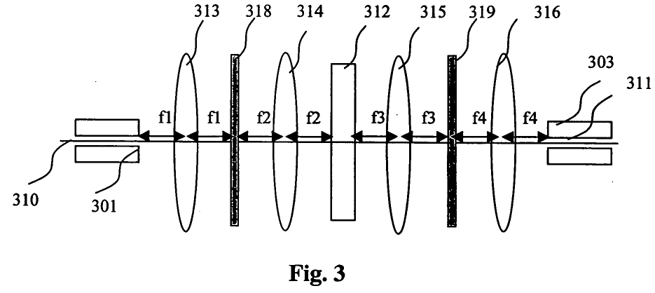

FIG. 3 shows an optical spatial modulator according to an embodiment of the invention;

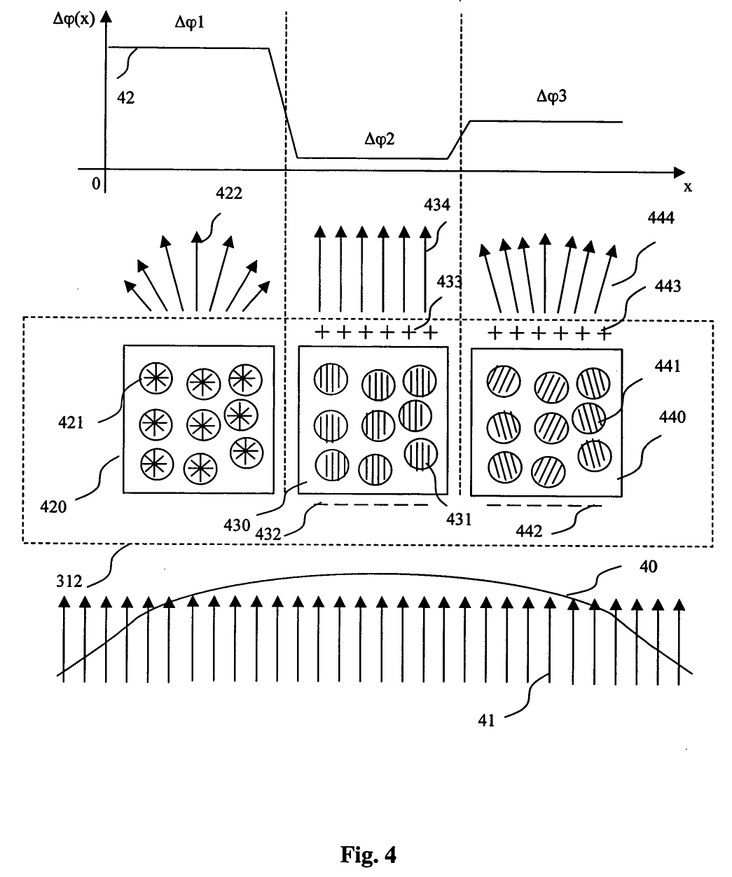

FIG. 4 describes a strip of cells used in the modulator in FIG. 3;

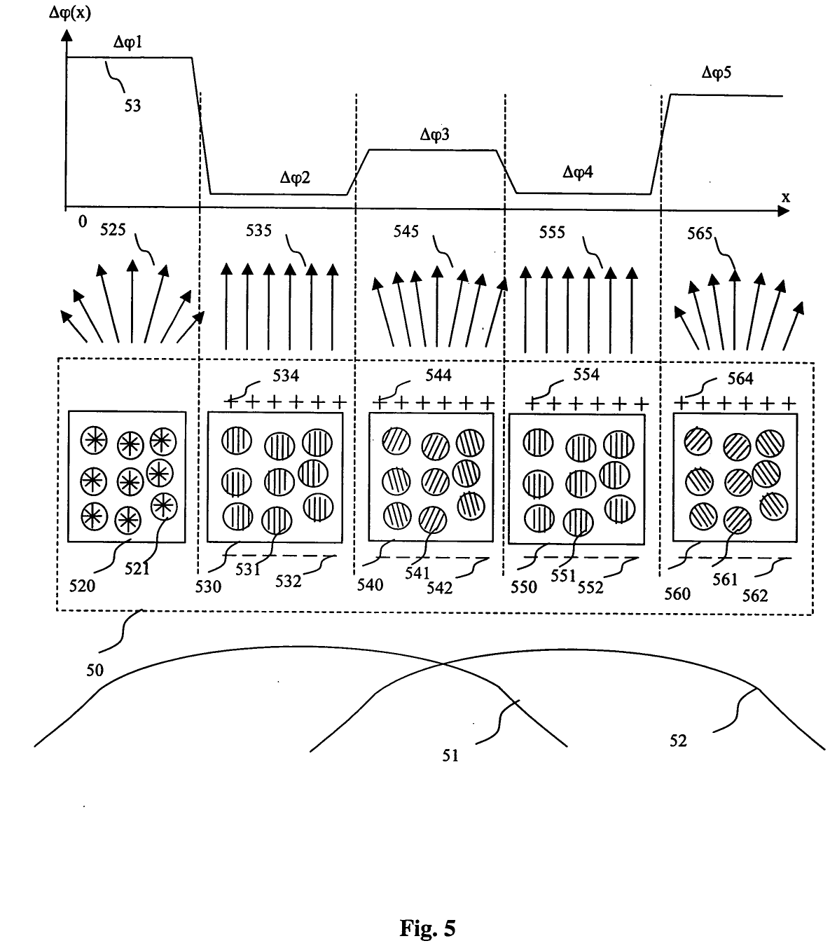

FIG. 5 shows a strip of cells according to another embodiment of the invention.

The general principle of the invention is based on the use of PDLC in a strip of several cells, one or several incident optical beams illuminating several cells. The use of a PDLC when the optical signal covers several pixels provides a means of combining the effects of attenuation by scattering and creation of a phase aberration, with relatively large and easily obtained phase shifts. Note that control of phase modulation is not independent of the amplitude modulation (therefore this is a special case of a complex amplitude modulation). The result is a combination of intensity modulation and spatial phase modulation.

For example, according to the invention, an attenuation of the order of 5 dB and a phase variation exceeding π is obtained with an elementary cell and a 20 μm thick standard PDLC, at a voltage of 40 Volts and an electric field of 2 V/μm.

The composite can be optimised between phase shift scattering (particularly optimisation of the droplet size). The optimum may be obtained by making the best choice of concentrations and the UV insolation process.

A PDLC is characterized by dispersion of liquid crystal droplets in a polymer matrix with an average diameter of the order of 1 to 4 μm. For example, it can be obtained by polymerisation at a wavelength of between 340 and 400 nm, preferably 365 nm, of a photopolymerisable monomer with an optical flux of 15 to 100 mW/cm² for a typical liquid crystal concentration of 75 to 80%.

A nano-PDLC is characterised by a dispersion of liquid crystal droplets in a polymer matrix with a much smaller average diameter of the order of 50 to 150 nm. For example, it can be obtained with the same constituents as PDLC by polymerisation at a wavelength of between 340 and 400 nm, preferably 365 nm, of a photopolymerisable monomer with an optical flux of 100 to 350 mW/cm² for a typical liquid crystal concentration of 65 to 70%.

Thus, the droplet size differentiates PDLC and nano-PDLC, this size depending on the initial concentration of liquid crystal, the UV insolation power and the concentration of mixtures, at the time of manufacturing.

Considering the higher concentration of liquid crystal in a PDLC (compared with a nano-PDLC), the resulting phase shift is greater than in the case of a nano-PDLC for the same cell thickness. Therefore, an equivalent phase shift can be obtained for a smaller thickness. This aspect added to the existence of lower anchor forces causes the use of lower voltages in the case of nano-PDLC and advantageous use of PDLC within the scope of the invention.

According to the invention, a compromise can be found between two phases, in particular by varying the liquid crystal concentration.

FIG. 3 illustrates a DSE (Dynamic Spatial Equaliser) that includes DCE (Dynamic Channel Equaliser) or DGE (Dynamic Gain Equaliser) type devices in free space including a filter strip 312 according to the invention placed between two single-mode optical fibres 301 and 303, the first being used for propagation of an incident beam 310 and the second for an output beam 311 (assembly in transmission).

More precisely, the DSE comprises the following in sequence:
an input fibre 310 carrying an optical beam 310;
a first imagery system adapted to creating a spatially demultiplexed image from the optical beam 310 (as a function of its wavelengths) on filter 312;
the filter strip 312;
a second imagery system adapted to creating a multiplexed image at the input to an output fibre 303 from the image of the beam passing through the filter strip 312; and
the output fibre 303 carrying a beam 311 equalised by the filter strip 312 as a function of the wavelengths of the incident beam 310, so that the beam size can be adapted to the dimensions of the pixel of the spatial modulator if necessary.

According to one variant of the invention, collimation means are placed between the input fibre 301 and the first imagery system and between the second imagery system and the output fibre 303. These collimation means are preferably adjacent to input fibre 301 and output fibre 303 respectively. In particular, they enable adjustment of the beam size.

The first imagery system comprises the following in sequence:
a lens 313 with focal length f1 located at the distance f1 of the output from fibre 301;
a demultiplexer 318 (for example a prism or a grating) adapted to spatially demultiplexing the incident beam as a function of its wavelength(s) and located at distance f1 from lens 313, therefore the incident beam being imaged on the demultiplexer 318;
a lens 314 with focal length f2 located at the distance f2 from the demultiplexer 318 and the filter strip 312, therefore the demultiplexed beam being imaged (with its spectral components spatially separated) on the strip 312.

The second imagery system comprises the following in sequence:
a lens 315 with focal length f3 located at the distance f3 from the strip 312;
a multiplexer 319 (for example a prism or a grating) adapted to multiplexing the incident beam equalised by the strip 312 as a function of its spectral components, and located at distance f3 from the strip;
a lens 316 with focal length f4 located at the distance f4 from the multiplexer 319 and the output fibre 303, therefore the multiplexed and equalised beam being imaged on the output fibre 303.

Depending on the variant embodiments of the system illustrated with reference to FIG. 3, optical elements adapted to perform a function specific to the system (particularly a wavelength demultiplexing element) are introduced into the focal planes of lenses in imagery systems (in replacement of or in addition to multiplexers/demultiplexers 318 and 319).

It will also be noted that with this principle, there are two feasible configurations with or without overlap of the incident optical beams, for example by varying the size of the beam and/or the dispersion capacity of the grating, with a result on the choice of possible functions (for example DGE vs DCE).

According to another variant of the invention corresponding to a folded (or reflected) mounting, the DSE comprises a mirror adjacent to the filter strip 312, the incident beam then being reflected to the demultiplexer 318 that then performs a multiplexing function on the reflected beam, the lenses 313 and 314 and an output fibre.

According to the first configuration illustrated with reference to FIG. 4, an incident optical beam 41 passes through the strip 312, and at least one part illuminates (illustrated by its Gaussian envelope amplitude 40) several cells 420, 430 and 440 of the strip 312 each including PDLC, without any overlap between the independent wavelengths or spectral bands of the incident beam 40. This configuration is particularly suitable for channel equalisation selection mode (DCE).

Each cell 420, 430 and 440 may be controlled independently of the other cells by transverse electrodes placed on each side of the corresponding cell. For illustration, the cell 420 is not subjected to any electric field at a given moment. Therefore the droplets 421 of PDLC contained in it scatter the incident beam 41, the output beam 422 also having a strong phase shift by a value Δδ1 (the phase shift Δδ(x) of the output beams being represented on curve 42 as a function of the longitudinal dispersion axis Ox, showing the spatial variation on this axis). The adjacent cell 430 is subjected to a relatively strong electric field of the order of 40 Volts for a 20 μm thick cell. The PDLC droplets 431 that it contains are all oriented such that they are transparent for the incident beam 41. The corresponding output beam 434 is then phase shifted by a minimum value Δδ2 and it remains in the same propagation direction as the incident beam 41 (no scattering). The next cell 440 is subjected to a relatively weaker electric field of the order of 20 Volts, for the same 20 μm thick cell. The PDLC droplets 441 contained in it are all oriented such that the corresponding cell is semi-transparent for the incident beam 41. The corresponding output beam 444 is then phase shifted by an intermediate value Δδ3 and is slightly scattered.

The model for voltage control of amplitude modulation of the complex amplitude is optimised as a function of the specifications of the required system (particularly the steepness or slope of the attenuation and the spectral resolution are free parameters that can be adapted on request). The voltage to be applied is adjusted by a theoretical study, or preferably using an optical counter-reaction. Thus for example, the best voltage associations can be adjusted using a set-up involving an optical source (for example a laser), the strip 312, a voltage source and optical display means for the resultant attenuation (using the optical counter-reaction).

According to one variant embodiment of the invention, the size of the droplets can be adjusted so as to optimise the given attenuation/phase shift ratio as an additional degree of freedom.

According to the second configuration illustrated with reference to FIG. 5, a quasi continuous spectrum equalisation is obtained using partial overlap of several incident optical beams 51 and 52, with the result that pixels are put in common (and therefore it is different in its principle from patent EP1207418 deposited by the Alcatel (registered trademark) company mentioned above).

An optimum number of pixels per band/pixels in common is determined as a function of system specifications. For a given spectral band width, this parameter is adjusted by varying the dispersion of the dispersive element and/or the size of the optical beam using a magnification system (for example corresponding to the variant described above, that implements collimation means between the input fibre and the first imagery system and between the second imagery system and the output fibre).

According to the first configuration illustrated with reference to FIG. 5, the strip 312 is replaced by a strip 50 in the system illustrated with reference to FIG. 3.

At least two distinct incident optical beams 51 and 52 pass through the strip 50 (only their amplitude is shown in FIG. 5), and each of these two beams illuminates several cells (520, 530, 540 for beam 51 and 540, 550 and 560 for beam 52) of the strip 312 and each including PDLC, the cell 540 being illuminated by the two beams. Therefore, there is an overlap between the wavelengths or spectral bands of the incident beams 51 and 52 on at least one cell of the strip 50. This configuration is particularly suitable for dynamic gain equaliser (DGE) selection mode.

Each cell in the strip 50 is controlled independently from the other cells by transverse electrodes (532, 542, 552, 562, 534, 544, 554 and 564) placed on each side of the corresponding cell. For illustration purposes, cell 520 is not subjected to any electric field at a given instant. Therefore the PDLC droplets 521 contained in it scatter the incident beam 51, the output beam 525 also being strongly phase-shifted by a value Δδ1 (the phase shift Δδ of the output beams being shown on curve 53). At a given moment, the adjacent cell 530 is affected by a relatively strong electric field of the order of 40 Volts for a 20 μm thick cell. The PDLC droplets 531 contained in it are all oriented such that they are transparent for the incident beam 51. The corresponding output beam 535 is then phase shifted by a minimum value Δδ2 and remains in the same propagation direction as the incident beam 51 (no scattering). The next cell 540 is subjected to a relatively weaker electric field of the order of 20 Volts for the same 20 μm thick cell. The PDLC droplets 541 that it contains are all oriented such that they are semi-transparent for incident beams 51 and 52. The corresponding output beam 545 (including the contribution of the two beams 51 and 52) is then phase shifted by an intermediate value Δδ3 and is slightly scattered. The next cell 550 is itself subjected to a strong electric field and its behaviour towards the beam 52 is the same as the behaviour of cell 530 towards the beam 51 (output beam phase shifted by a minimum value Δδ4 and remaining in the same propagation direction as the incident beam 52 (no scattering)). The next cell 560 subjected to an average field is phase shifted by an intermediate value Δδ5 and is slightly scattered.

In practice, it is possible to change from the configuration illustrated in FIG. 4 to the configuration illustrated with reference to FIG. 5, while keeping the same strip 312 and modifying the size of the incident spot and/or the dispersion capacity that can be adjusted to enable the required overlap. However, a strip with a different pixel size can be useful to enable better adjustment of optical parameters.

Obviously, the invention is not limited to the example embodiments mentioned above.

In particular, the proposed principle using a complex amplitude modulation can be extended according to the invention to use other electro-optical materials, and particularly solid semiconductors operating at a wavelength slightly less than the gap or quantum well semi-conductors (MPQ).

Furthermore, those skilled in the art could make any variant in the form of new cell groups which, according to the invention, could be arranged in the form of strips (cells arranged along a single dimension approximately perpendicular to the incident beam(s) or matrices (cells arranged along two dimensions in a plane transverse to the incident beam(s)).

1. An optical equalisation device (312, 50) of at least one incident optical beam (40, 51, 52) separated in wavelength into several channels or spectral bands called demultiplexed optical beam, the said device including at least two independently controllable cells (420, 430, 440, 520, 530, 540, 550, 560) each comprising spatial phase modulation means and means of scattering the said incident optical beam(s), wherein
the said device is adapted such that at least one of the demultiplexed beams (312, 51) simultaneously and approximately illuminates at least two of the said cells (420, 430, 440, 520, 530, 540)
and in that the said consecutive spectral bands (51, 52) of the said demultiplexed optical beam overlap partly on at least one of the said cells (540).

2. Device according to claim 1, wherein the said device is adapted such that at least one of the said demultiplexed beams simultaneously and approximately illuminates three of the said cells.

3. Device according to claim 1, wherein the said spatial modulation means and the said scattering means comprise a liquid crystal type composite material (421, 431, 441, 521, 531, 541, 551, 561) in a polymer.

4. Device according to claim 3, wherein the said material comprises liquid crystal droplets with a size more than one tenth of the incident wavelength.

5. Device according to claim 4, wherein the said material comprises liquid crystal droplets with a size approximately equal to the incident wavelength.

6. Device according to claim 3, wherein the liquid crystal concentration in the said material is between 75 and 80%.

7. Device according to claim 1, wherein the said spatial modulation means and the said scattering means include a bulk semi conducting material.

8. Device according to claim 1, wherein the said spatial modulation means and the said scattering means are of the multiple quantum well type.

9. System wherein it comprises wavelength multiplexing means and a device according to claim 1.

10. System according to claim 9, wherein it is used in free space.
